(19) United States
(12) Patent Application Publication
(10) Pub. No.: US 2005/0280724 A1
(43) Pub. Date: Dec. 22, 2005

(54) Image signal-processing device, method for processing image signal, image signal-processing program product, control device for solid image capturing element, and method for controlling solid image capturing element

(75) Inventor: Yoshihito Higashitsutsumi, Mizuho-shi (JP)

Correspondence Address: HOGAN & HARTSON L.L.P., 500 S. GRAND AVENUE, SUITE 1900, LOS ANGELES, CA, 90071-2611, US

(73) Assignee: SANYO ELECTRIC CO., LTD.

(21) Appl. No.: 11/002,733

(22) Filed: Dec. 2, 2004

(30) Foreign Application Priority Data
Dec. 3, 2003 (JP) 2003-404224

(51) Int. Cl. H04N 5/225

(52) U.S. Cl. 348/241

(57) ABSTRACT

A method for processing image signal including a step for determining whether a value of a image signal outputted from an observation pixel is larger than a signal value equivalent to a quantity of saturated electric charge storable in an observation pixel at the time of image capturing by making one pixel contained in a solid image capturing section as the observation pixel, and another step for subtracting the signal value equivalent to the quantity of saturated electric charge from the value of the image signal outputted from the observation pixel when the value of the image signal outputted from the observation pixel is determined to be larger than the signal value equivalent to the quantity of saturated electric charge storable in the observation pixel at the time of image capturing.

### CROSS-REFERENCE TO RELATED APPLICATION

The entire disclosure of Japanese Application No. 2003-404224 including specification, claims, drawings, and abstract is incorporated herein by reference in its entirety

### BACKGROUND OF THE INVENTION

1. Field of the Invention

The present invention relates to a image signal processing device, a method for processing the image signal, and a image signal processing program product for improving a picture quality of a video signal obtained by an image capturing element, and also to a control device of a solid image capturing element and a method for controlling the solid image capturing element suitable for an improvement of the picture quality of the video signal.

2. Description of the Related Art

A CCD (Charge Coupled Device) solid image capturing element is an electric charge transfer element capable of moving information electric charge in sequence as a mass of signal packets in one direction at a speed synchronized with an outside clock pulse.

The CCD solid image capturing element of a frame transfer system includes, as shown in FIG. 7, an image capturing section 2i, a storing section 2s, a horizontal transfer section 2h, and an output section 2d. The image capturing section 2i includes a vertical shift register (not shown) including a plurality of shift registers mutually extended in parallel in the vertical direction (longitudinal direction in FIG. 7), and each bit of the respective shift registers functions as one of photo detector pixels respectively arranged as a two-dimensional matrix. The storing section 2s is also made up by including a vertical shift register (not shown) including a plurality of shift registers mutually extended in parallel in the vertical direction (longitudinal direction in FIG. 7). The vertical shift register included in the storing section 2s is masked against light beams, and each bit of the respective shift registers functions as a storing pixel for storing information electric charge. The horizontal transfer section 2h is made up by including a horizontal shift register (not shown) arranged extended in the horizontal direction (lateral direction in FIG. 7), and respective bits of the horizontal shift register are connected to outputs of the respective shift registers of the storing section 2s. The output section 2d is made up by including a reset transistor (not shown) for discharging capacitance which temporarily stores the electric charge transferred from the horizontal shift register of the horizontal transfer sections 2h and the electric charge stored in the capacitance.

Light beams impinged onto the image capturing section 2i are photo-electrically converted by a photo detector pixel (not shown) making up respective bits of the image capturing section 2i to produce an information electric charge. The two-dimensional matrix of the information electric charge produced in the image capturing section 2i is transferred at high speed to the storing section 2s by the vertical shift register of the image capturing section 2i, thereby one frame portion of the information electric charge is held in the vertical shift register of the storing section 2s. Then, the information electric charge is transferred from the storing section 2s to the horizontal transfer section 2h by one row each. Further, the information electric charge is transferred from the horizontal transfer section 2h to the output section 2d in one pixel unit. The output section 2d converts the quantity of electric charge of each one pixel into a voltage value, and the change in the voltage value is made as a CCD output.

The image capturing section 2i and the storing section 2s are made up of a plurality of shift registers formed on surface region of an N-type semiconductor substrate 10, as shown in FIG. 8A which shows a plan view of the interior of the CCD solid image element. FIG. 8B shows a sectional view of the CCD solid image element along an A-A line in FIG. 8A. Here, in order to make a description more simplified for explanation, only a portion of the image capturing section 2i and storing section 2s is shown.

Within the N-type semiconductor substrate (N-SUB) 10, a P well (PW) 12 is formed, and an N well (NW) 14 is formed thereon. In other words, the P well 12 is formed by adding a P-type impurity on the N-type semiconductor substrate 10. The N well 14 is formed by adding an N-type impurity in high density on the surface region of the P well. Furthermore, separation areas 16 made of the P-type impurity areas are formed by ion implantation of the P-type impurity onto the surface region of the N well 14 mutually in parallel with a predetermined space. The N well 14 is electrically divided by the neighboring separation areas 16, and an area sandwiched by these separation areas 16 makes up a channel area 22, which is a transfer channel of the information electric charge. The separation areas 16 form potential barriers between the neighboring channel areas to electrically separate the respective channel areas 22.

An insulation film 18 is formed on the surface of the semiconductor substrate 10. A plurality of transfer electrodes 26 (26-1, 26-2, and 26-3) (shown in FIG. 8A) made of a polysilicon film are arranged mutually in parallel so as to orthogonally intersect the extending direction of the channel areas 22 on the insulation film 18. Here, a combination of the neighboring three transfer electrodes 26-1, 26-2, and 26-3 is equivalent to one pixel.

As shown in FIG. 9, voltages are applied to the transfer electrodes 26-1, 26-2, and 26-3 (shown in FIG. 8A). FIGS. 10(a) and 10(b) show states of the potential distribution in the N well 14 along the extending direction of the channel areas 22 in an image capturing period and a transfer period. At the time of image capturing, for example, as shown in FIG. 9, one transfer electrode 26-2 out of the set of the transfer electrodes 26 is put in a turned-on state, thereby a potential well 32 is formed in the channel area 22 under the transfer electrode 26-2 as shown in FIG. 10(a). By putting the remaining transfer electrodes 26-1 and 26-3 in a turned-off state, information electric charge 30 is stored in the potential well 32 under the transfer electrodes 26-2.

At the time of transfer, transfer clocks φ1 to φ3 of three phases, the phases being mutually shifted, are applied to respective combinations of the neighboring three transfer electrodes 26-1, 26-2, and 26-3, as shown in FIG. 9. As the result, as shown in FIG. 10(b), the potential well 32 which is formed in the channel area 22 located under the transfer electrodes 26-1, 26-2, and 26-3, is moved in sequence toward the transfer direction. Thus, the information electric charge 30 is transferred along the extending direction of the channel area 22.

For example, as shown in FIG. 11, an assumption is made that, in the image capturing section 2i, pixels (i, j) are arranged in a matrix, where I rows (i=1 to I) of the pixels are arranged vertical to the transfer direction and J columns (j=1 to J) of the pixels are arranged horizontal to the transfer direction.

As shown in FIG. 12(a), an information electric charge Q_{i,j} is stored in the potential wells 32 of the pixels (i, j) during an image capturing period Tₛ. Each time one cycle of the transfer clock is applied to the transfer electrodes 26-1 to 26-3, the information electric charge Q_{i,j} is transferred in sequence from the pixel nearest to the storing section 2s to the storing section 2s, which is masked against the light beams, as shown in FIGS. 12(c) and 12(d).

When a mechanical shutter is not provided, respective pixels (i, j) of the image capturing section 2i are continuously impinged by the light beams from the outside even during a transfer period, and new electric charge q_{i,j} is continuously added to the electric charge of the respective pixels (i, j), as shown in FIG. 12(b).

At this time, if pixels of J columns exist, and the time required in transferring the information electric charge of all the pixels to the storing section 2s, namely the transfer period, is assumed to be Tₜ, a transfer cycle T in which the information electric charge is transferred from the pixel (i, j) to the next pixel (i, j−1) is expressed by T=Tₜ/J, where Tₜ, being the transfer period, and J, being the number of the columns. In FIG. 13, shown is the relationship between the photo detection intensity at the pixel of the image capturing section 2i and the quantity of electric charge generated at the pixel during the image capturing period Tₛ and in the transfer cycle T. A ratio between the quantity of electric charge q_{i,j} generated at the time of passing an observation pixel (i, j) in the transfer cycle T and the information electric charge Q_{i,j} stored in the observation pixel (i, j) during the image capturing period Tₛ equals to the ratio between the transfer cycle T and the image capturing period Tₛ. In other words, the new electric charge q_{i,j} generated in the pixel (i, j) during the transfer of the information electric charge from the pixel (i, j) to the next pixel (i, j−1) equals to the product of the information electric charge Q_{i,j} stored in the pixel (i, j) during the image capturing period Tₛ and the ratio of T/Tₛ, where T being the transfer cycle and Tₛ being the image capturing period; this is because a photo detector intensity for the respective pixels (i, j) can be regarded to be a time-wise constant between the image capturing period Tₛ and the transfer cycle T.

For example, as shown in FIGS. 12(a) to 12(c), if the information electric charge is moved one pixel portion toward the transfer direction, the information electric charge Q_{i,1} is transferred to the neighboring storing section without being added with the new electric charge, but the electric charge q_{i,1}=Q_{i,1}×T/Tₛ is added to the information electric charge Q_{i,2}. Similarly, the electric charge q_{i,j-1}=Q_{i, j-1}×T/Tₛ is added to the information electric charge Q_{i,j} (j≧3) at the pixel (i, j−1). Furthermore, if the information electric charge is transferred further one pixel portion toward the transfer direction from the state shown in FIG. 12(c) to the state shown in FIG. 12(d), the information electric charge Q_{i,2} is transferred to the storing section 2s without the new electric charge being added, but the electric charge q_{i,1}=Q_{i,1}×T/Tₛ is added to the information electric charge Q_{j,3} at the pixel (i, 1). Similarly, the electric charge q_{i,j-2}=Q_{i, j-2}×T/Tₛ is added to the information electric charge Q_{i,j} (j≧4) at the pixel (i, j−2).

The information electric charge of the pixel nearer to the storing section 2s is immediately transferred to the storing section 2s which is masked against the light beams, thus is hardly affected by the electric charge generated during the transfer period. On the other hand, the information electric charge of the pixels far from the storing section 2s passes a number of pixels during the transfer toward the storing section 2s. Accordingly, the quantity of electric charge stored during the transfer period is increased, and thus is liable to be affected by the electric charge generated during the transfer period.

Ordinarily, since the transfer period Tₜ is set much shorter than the image capturing period Tₛ, the quantity of the electric charge to be added during the transfer period is much smaller than the quantity of the information electric charge generated during the image capturing period. Accordingly, influence of the electric charge stored during the transfer period normally causes no problem.

However, when impinged by strong light beams from the sun, an illumination, or the like of the high luminance, the quantity of the electric charge generated during the transfer period for the information electric charge generated during the image capturing period becomes too large to be ignored. As the result, as shown in FIG. 14, generated is a video image 202, which is drawn with a line in the vertical transfer direction from the pixel impinged by the strong light beams within an image 200. This phenomenon is called a smear. Moreover, the electric charge added during the transfer is called a smear electric charge.

In order to prevent generation of the smear, an effective device for use is a mechanical shutter for mechanically masking the image capturing section 2i during the transfer time of the information electric charge. However, the mechanical shutter is complicated in mechanical organization as well as in a control device thereof, and it is difficult to be mounted on anything other than a highly priced camera. Moreover, an actual circumstance is that the shutter cannot be mounted even on the camera, since the camera is necessitated to reduce the size thereof, for example in the case of a portable phone or the like.

Such being the situation, developed is a method for removing the smear by image processing of the video signals obtained by the CCD solid image-capturing element. The most general method thereof is a method called an offset smear removing method.

In the offset smear removing method, smear components are removed taking advantage of the fact that a ratio of q_{i,j}/Q_{i,j}, where q_{i,j} being the electric charge generated at the time of passing the observation pixel (i, j) during the transfer period and Q_{i,j} being the information electric charge stored in the observation pixel (i, j) during the image capturing period, equals to a ratio of T/Tₛ, where T being the transfer cycle and Tₛ being the image capturing period.

For example, as shown in FIG. 11, when the pixels of J columns are arranged in the transfer direction of the image capturing section 2i, and the information electric charge generated in the pixel (i, j) during the image capturing period Tₛ is Q_{i,j}, and the transfer period is Tₜ, a smear electric charge ΔQ_{i,j} to be added to the information electric charge Q_{i,j} during the transfer period can be expressed by a relation (1).

$$\begin{matrix}Δ {Q}_{i , 1} = 0 \\ Δ {Q}_{i , j} = \sum {Q}_{i , n} \\ = Δ {Q}_{i , j - 1} + {q}_{i , j - 1} \\ = Δ {Q}_{i , j - 1} + {Q}_{i , j - 1} \times ( {T}_{t} / J ) \div {T}_{s} , j ≧ 2\end{matrix} \qquad ( 1 )$$

A quantity of electric charge S_{i,j} transferred from the pixel (i, j) to the storing section 2s has a value,
S_{i,j}=Q_{i,j}+ΔQ_{i,j},
which is the value obtained by adding the smear electric charge ΔQ_{i,j} to the information electric charge Q_{i,j} stored in the pixel (i, j) during the image capturing period Tₛ. The smear can be removed from a photographed image by subtracting a voltage value equivalent to the smear electric charge ΔQ_{i,j} from the output value from the output section 2d obtained by finally converting the quantity of electric charge S_{i,j} into the voltage value, based on these relations.

However, when the image capturing section 2i is impinged by the strong light beams from the sun, illumination, or the like having a high luminance, the information electric charge generated during the image capturing period Tₛ is very much increased in the pixels contained in the area which is impinged by the strong light beams. When the light beams are exceptionally strong, as shown in FIGS. 13 and 15, the information electric charge 30 generated becomes larger than the quantity of saturated electric charge Qₘₐₓ storable in the potential well 32 formed by the voltage applied to the transfer electrodes 26, and an overflow of the information electric charge 30 is generated.

When the overflow of the information electric charge 30 is generated, the relationship between the electric charge Q_{i,j} stored during the image capturing period and the smear electric charge ΔQ_{i,j} cannot be expressed by the mathematical formula (1) since the electric charge generated during the transfer period Tₜ is not stored in the potential well 32. Accordingly, if the smear electric charge ΔQ_{i,j} is calculated by use of the mathematical formula (1), the smear electric charge ΔQ_{i,j} is estimated to be smaller than the quantity of electric charge actually generated. As the result, the smear cannot be removed completely by the conventional offset smear removing method thus creating a problem.

### SUMMARY OF THE INVENTION

An embodiment of the present invention is to provide a image signal-processing device for processing a image signal outputted from a solid image capturing element, characterized in that one of elements contained in said solid image capturing element is designated as an observation element, and a value obtained by subtracting a signal value equivalent to a quantity of saturated electric charge from the image signal outputted from said observation element is processed as a signal value equivalent to smear electric charge added during a transfer period of an electric charge, when a value of the image signal outputted from said observation element is larger than the signal value equivalent to said quantity of the saturated electric charge storable in said observation element at a image capturing period.

Another embodiment of the present invention is to provide a method for processing a image signal for processing the image signal outputted from a solid image capturing element, characterized in that one of the elements contained in said solid image capturing element is designated as an observation element, comprising; a first step for determining whether a value of the image signal outputted from said observation element is larger than a signal value equivalent to a quantity of saturated electric charge storable in said observation element at a image capturing period, and a second step for setting a value obtained by subtracting the signal value equivalent to said quantity of saturated electric charge from the value of the image signal outputted from said observation element as the signal value equivalent to a smear electric charge added during a transfer period of the electric charge, when the image signal outputted from said observation element is determined in said first step to be larger than the signal value equivalent to the quantity of saturated electric charge storable in said observation element at the image capturing period.

Further, another embodiment of the present invention is to provide a image signal processing program product for processing a image signal outputted from a solid image capturing element, characterized in that one of elements contained in said solid image capturing element is designated as an observation element, and the computer is rendered to function as a image signal processing device for processing a value obtained by subtracting a signal value equivalent to a quantity of saturated electric charge from the value of the image signal outputted from said observation element as a signal value equivalent to a smear electric charge added during a transfer period of the electric charge, when a value of the image signal outputted from said observation element is larger than the signal value equivalent to said quantity of the saturated electric charge storable in said observation element at a image capturing period.

Furthermore, another embodiment of the present invention is to provide a control device of a solid image capturing element provided with an image capturing section having a plurality of pixels arranged in a matrix for storing the electric charge generated in accordance with light beams received by the pixels in the image capturing period, and for transferring in sequence the electric charge stored in respective pixels during the transfer period, characterized in that a capacity of a potential well formed in the image capturing section during the transfer period is made larger than the capacity of the potential well formed in the image capturing section during the image capturing period.

Moreover, still another embodiment of the present invention is to provide a method for controlling a solid image capturing element provided with an image capturing section having a plurality of pixels arranged in a matrix for storing the electric charge generated in accordance with the light beams received by the pixels during the image capturing period and for transferring in sequence the electric charge stored in respective pixels during the transfer period, characterized in that the capacity of the potential well formed in the image capturing section during the transfer period is made larger than the capacity of the potential well formed in the image capturing section during the image capturing period.

The other objects, features, and advantages of the present invention are set forth in or will become apparent from the following detailed description of the invention when read in conjunction with the accompanying drawings.

### BRIEF DESCRIPTION OF THE DRAWINGS

FIG. 1 is a block diagram showing a make-up and connection relationship with a CCD solid image capturing element of a control device and a image signal processing device according to an embodiment of the present invention;

FIG. 2 is a diagram showing a timing chart of transfer clocks from the control device according to the embodiment of the present invention;

FIGS. 3(a) and 3(b) are schematic views showing potentials of the image capturing sections at the times of image capturing and of transfer according to the embodiment of the present invention;

FIGS. 4A and 4B are schematic views showing changes of electric charge at the time of transfer according to the embodiment of the present invention;

FIG. 5 is a flowchart showing steps of a method for processing image signals according to the embodiment of the present invention;

FIG. 6 is a graph showing relationship between a photo detector intensity and an electric charge generated during an image capturing period and in a transfer cycle according to the embodiment of the present invention;

FIG. 7 is a schematic view showing constitution of a CCD solid image capturing element of a related art;

FIG. 8A is a plan view showing an interior of elements of an image capturing section and a storing section of the CCD solid image capturing element of the related art;

FIG. 8B is a side sectional view showing the interior of the element of the image capturing section and the storing section of the CCD solid image capturing element of the related art;

FIG. 9 is a diagram showing a timing chart of a transfer clock in the related art;

FIGS. 10(a) and 10(b) are schematic views showing states of potentials of the image capturing section at the times of image capturing and of transfer in the related art;

FIG. 11 is a schematic view showing an example of the CCD solid image capturing element provided with an image capturing section having pixels of 10 rows by 10 columns of the related art;

FIGS. 12(a), 12(b), 12(c), and 12(d) are schematic views for explaining states of storing of a smear electric charge at the time of transfer in the related art;

FIG. 13 is a graph showing a relationship between a photo detector intensity and an electric charge generated during an image capturing period and in a transfer cycle in the related art;

FIG. 14 is a view showing an example of an image in which a smear is generated in the related conventional art; and

FIG. 15 is a view for explaining a potential well in which an overflow is generated in the related art.

### DESCRIPTION OF THE PREFERRED EMBODIMENTS

Exemplary embodiments of the present invention will be explained in detail with reference to the accompanying drawings.

Note that the invention is not limited thereto.

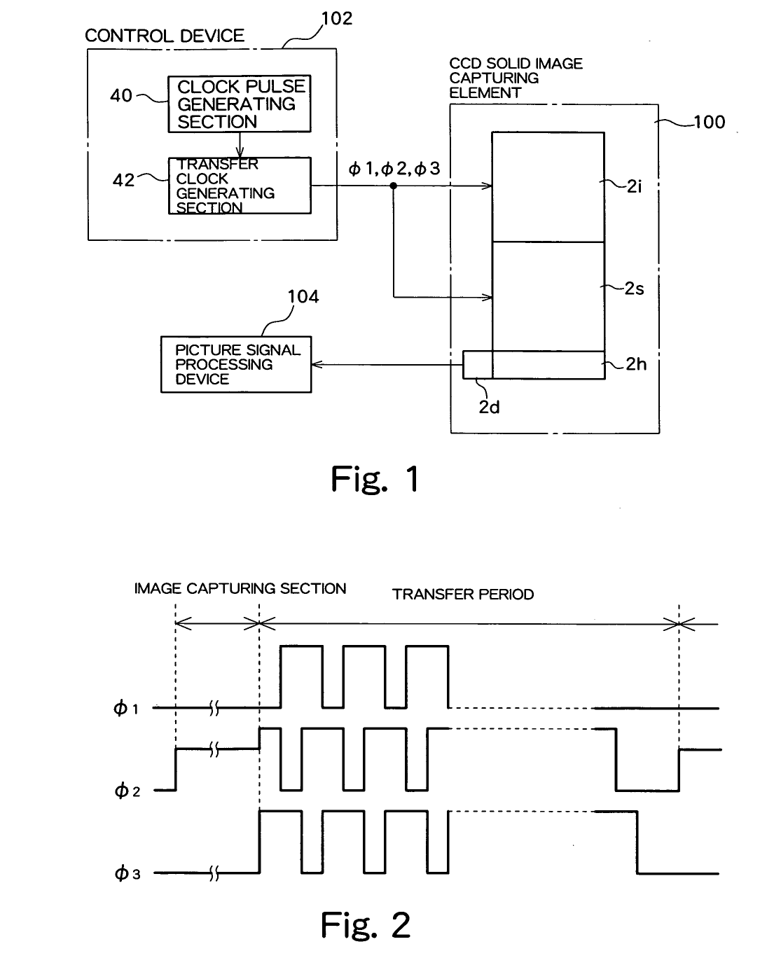

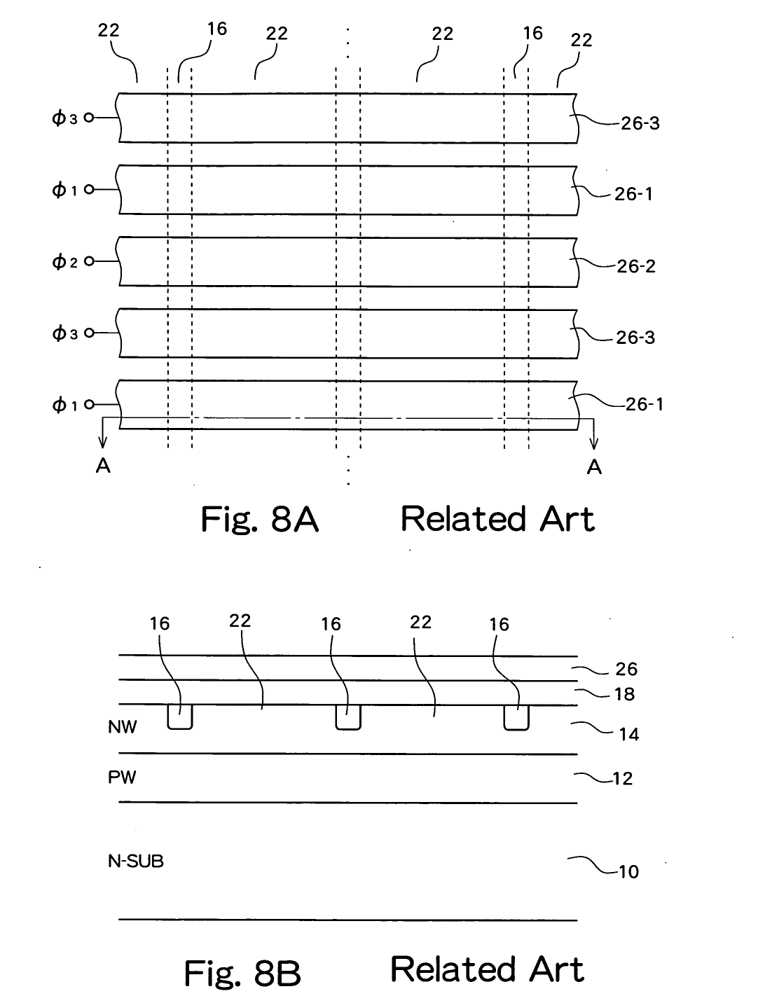

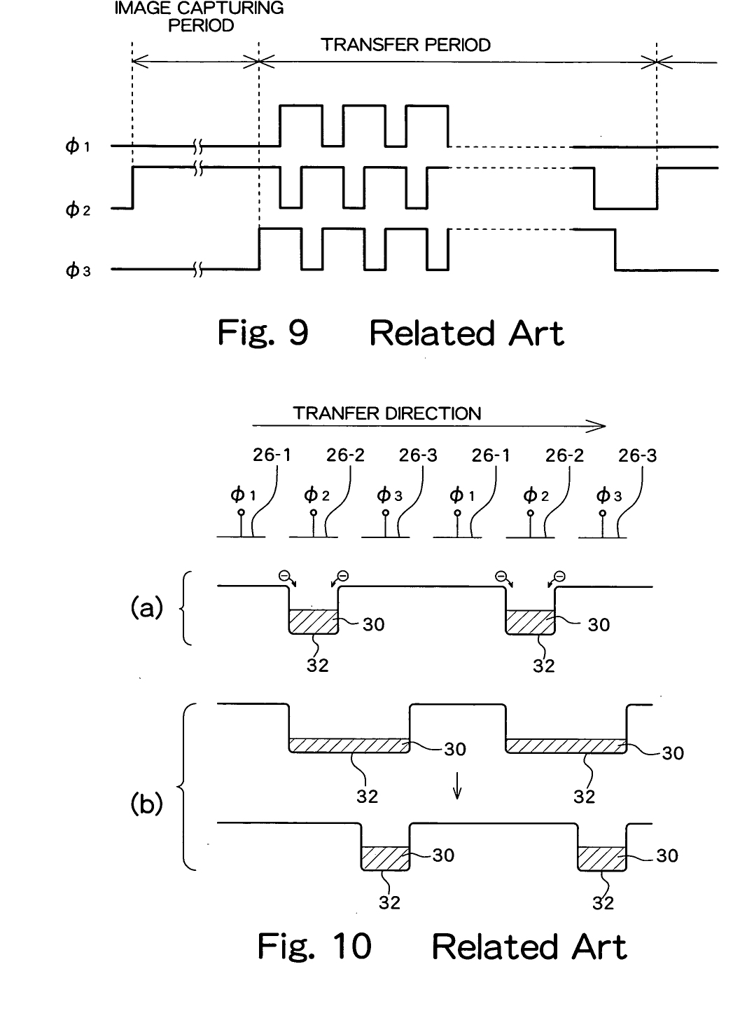

A CCD (Charge Coupled Device) solid image capturing element used in the embodiment of the present invention includes an image capturing section 2i, a storing section 2s, a horizontal transfer section 2h, and an output section 2d(shown in FIG. 1), as in the conventional CCD image capturing element shown in FIG. 7 (Parts that are the same have been assigned the same reference numbers as in the related conventional art although their applications are not necessarily the same). Further, the make-up of the image capturing section 2i and the storing section 2s can be the same as the conventional ones shown in FIGS. 8A and 8B. Accordingly, the description about the make-up of the CCD solid image-capturing element is omitted.

A CCD solid image capturing element 100 is connected to a control device 102 and a image signal-processing device 104, as shown in FIG. 1. The control device 102 includes a clock pulse generating section 40 and a transfer clock generating section 42. The clock pulse generating section 40 includes an oscillating element (not shown) such as a quartz oscillating element or the like, and outputs timing pulses to the transfer clock generating section 42. The transfer clock generating section 42 receives timing pulses to generate transfer clocks φ1, φ2, and φ3 to be applied to transfer electrodes 26 (26-1, 26-2, and 26-3) of the image capturing section 2i and the storing section 2s. The transfer clocks φ1, φ2, and φ3 are applied respectively to the transfer electrodes 26-1, 26-2, and 26-3.

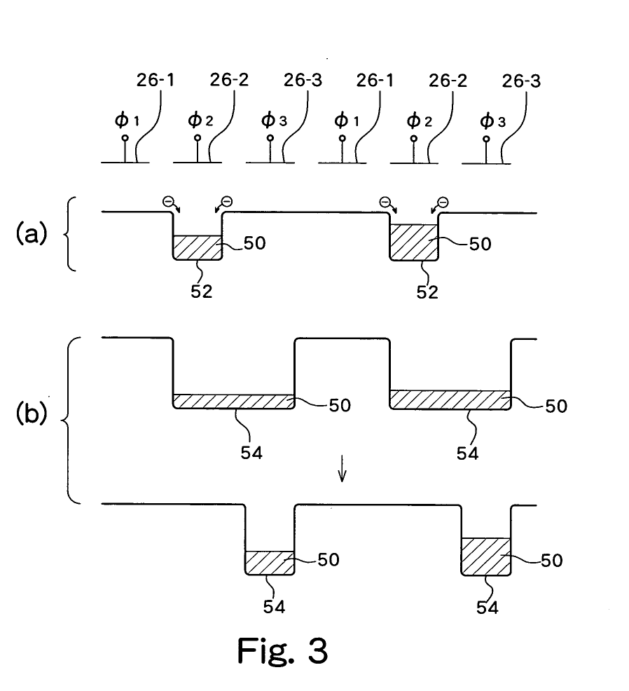

FIG. 2 shows timing charts of the transfer clocks φ1, φ2, and φ3 to be applied to the transfer electrodes 26-1, 26-2, and 26-3. FIGS. 3(a) and 3(b) show states of potential distribution in an N well 14 along an extending direction of a channel area 22 during an image capturing period and a transfer period. At a time of image capturing, for example, as shown in FIG. 2, one transfer electrode 26-2 out of a set of the transfer electrodes 26 is put into a turned-on state, thereby a potential well 52 is formed in the channel area 22 under the transfer electrode 26-2, as shown in FIG. 3(a). By putting the remaining transfer electrodes 26-1 and 26-3 into a turned-off state, an information electric charge 50 is stored in the potential well 52 under the transfer electrode 26-2.

At the time of transfer, as shown in FIG. 2, the transfer clocks φ1, φ2, and φ3 of three phases, the phases being mutually shifted, are applied to respective combinations of the neighboring three transfer electrodes 26-1, 26-2, and 26-3, thereby potential wells 54 formed in the channel area 22 located under the transfer electrodes 26-1, 26-2, and 26-3 are moved in sequence toward the transfer direction, and the information electric charge 50 is transferred along the extending direction of the channel area 22, as shown in FIG. 3(b).

At this time, as shown in FIG. 2, the amplitude of the pulse of the respective transfer clocks φ1, φ2, and φ3 during the transfer period is set larger than the amplitude of the pulse during the image capturing period, thereby the potential well 54 of the transfer period is formed deeper than the potential well 52 of the image capturing period.

Here, it is preferable that the amplitude of the pulse of the respective transfer clocks 1, φ2, and φ3 during the transfer period is set such that the potential well 54 has a capacity of the degree not to overflow even if a smear electric charge generated during the transfer period is added to the information electric charge 50. In other words, even when strong light beams impinge on the image capturing section 2i at a time of photographing to generate the information electric charge of a degree to overflow from the potential well 52 at the time of image capturing, regulation is made to have a enough capacity in the degree such that the potential well 54 is not overflowed by the smear electric charge generated during the transfer period.

The image signal-processing device 104 may be substituted by a computer containing an interface having an analog-to-digital converter provided therein. A voltage outputted from the output section 2d of the CCD solid image capturing element 100 is subjected to the analog-to-digital conversion by the interface of the image signal processing device 104 for inputting into the image signal processing device 104.

The image signal-processing device 104 performs a image signal processing. The method for processing the image signal in the present embodiment may be subjected to coding as a program product practicable by the computer, and executed by the image signal-processing device 104.

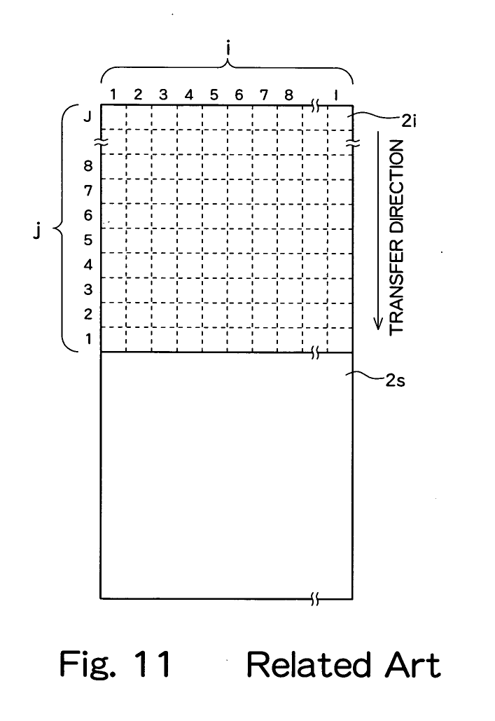

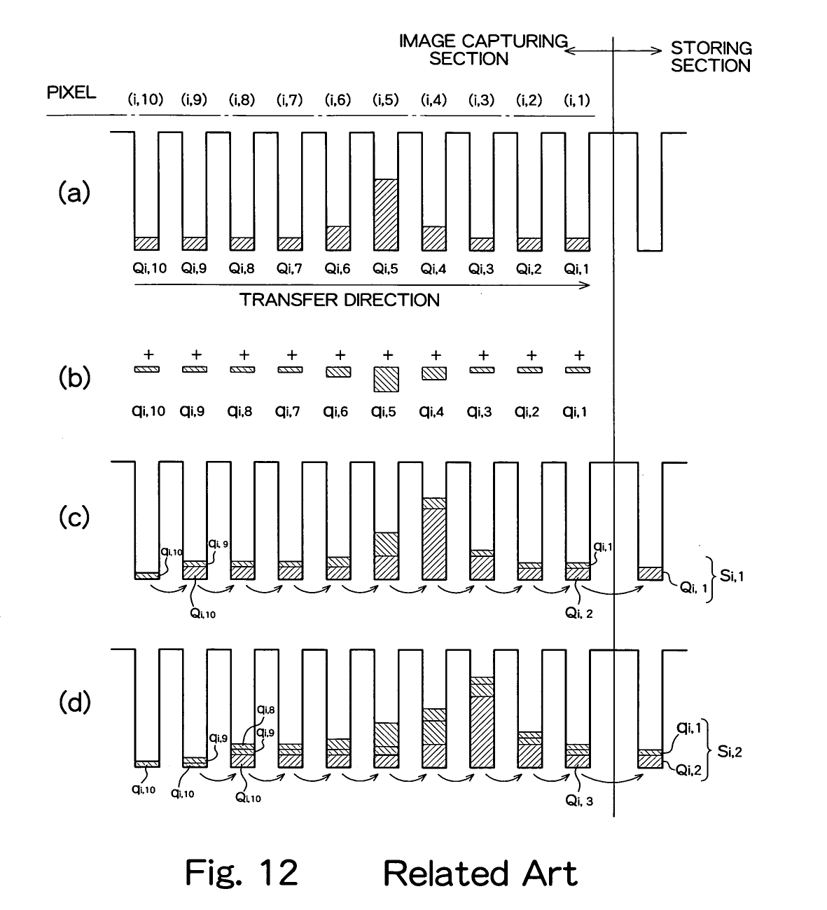

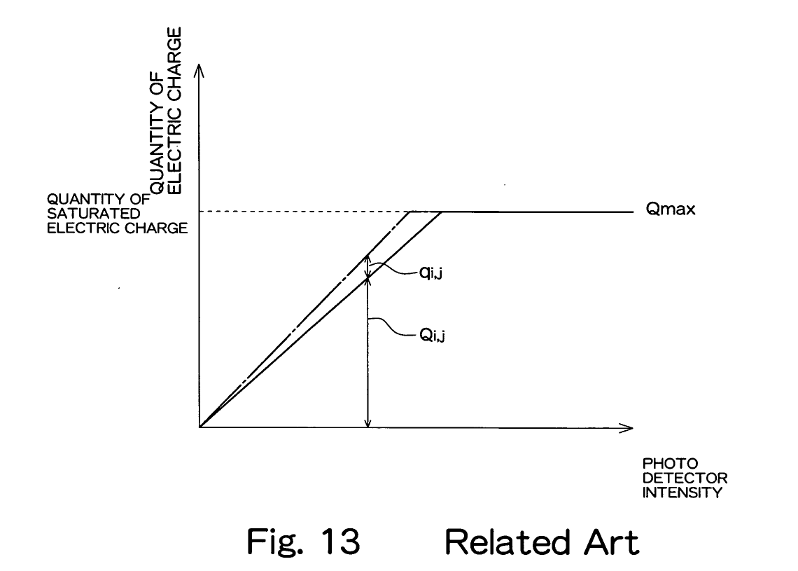

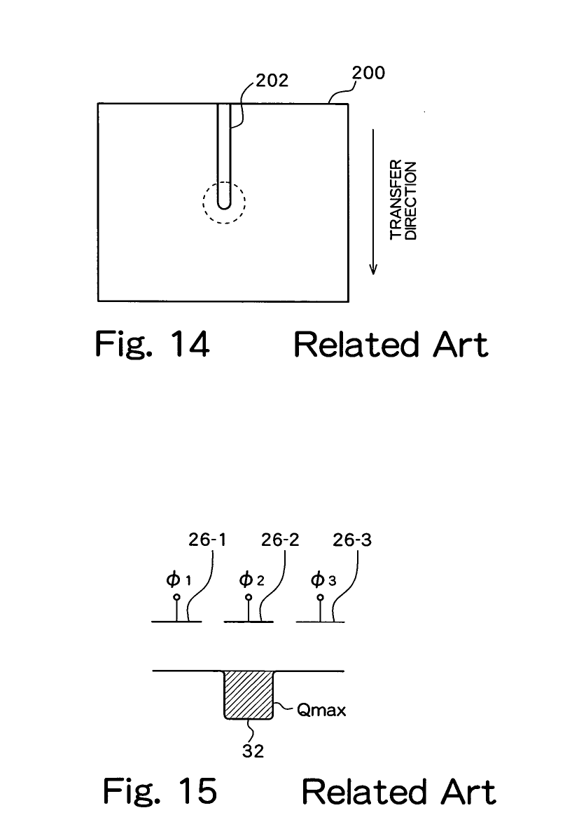

Hereinafter, description will be made on a hypothesis that pixels (i, j) are arranged in a matrix in the image capturing section 2i, as shown in FIG. 11. In other words, J columns of pixels are supposed to be arranged along the transfer direction in the image capturing section 2i.

During an image capturing period Tₛ, an information electric charge Q_{i, j} is stored in the potential well 52 of the pixel (i, j). At this time, the quantity of electric charge overflowing the potential well 52 is a quantity of saturated electric charge Qₘₐₓ. Further, the information electric charge 50 of all the pixels (i,j) is transferred to the storing section 2s during a transfer period Tₜ. A smear electric charge ΔQ_{i, j} is added to the information electric charge Q_{i, j} during the transfer period Tₜ.

When the potential well 54 formed during the transfer period Tₜ is formed deeper than the potential well 52 in the image capturing period Tₛ, the smear electric charge ΔQ_{i, j} can be expressed in different relations depending on whether the overflow is generated at the time of image capturing.

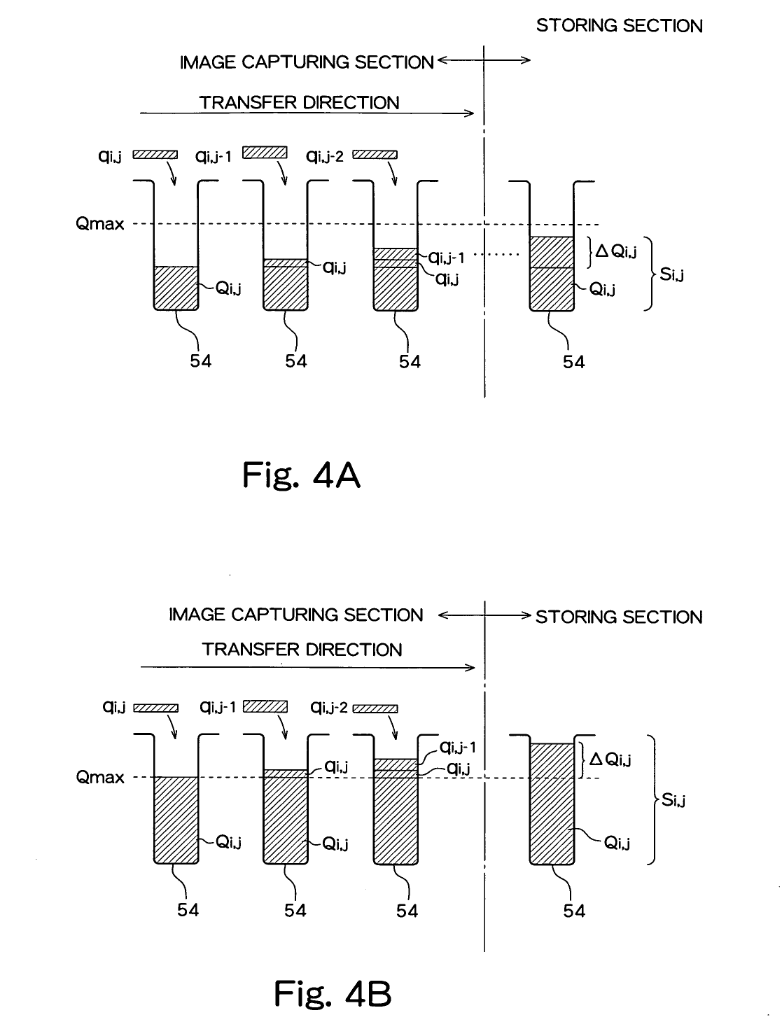

When the potential well 52 of the pixel (i, j) is not overflowed at the time of image capturing, the smear electric charge ΔQ_{i, j} has a quantity made by adding in sequence quantities of electric charge q_{i, j}, q_{i, j-1} . . . generated at the pixels (i,j) which it passes until its arrival at the storing section 2s, as shown in FIG. 4A. A quantity of electric charge S_{i, j} transferred from the pixel (i, j) to the storing section 2s is a sum of the quantity of information electric charge Q_{i, j} and the quantity of smear electric charge ΔQ_{i, j}.

Whether the overflow is generated is determined by whether the quantity of electric charge S_{i, j} exceeds the quantity of saturated electric charge Qₘₐₓ. When the relationship between the quantity of electric charge S_{i,j} and the quantity of saturated electric charge Qₘₐₓ is expressed by;
S_{i, j}≦Qₘₐₓ,
the smear electric charge ΔQ_{i, j} can be expressed by the mathematical formula (1) in the same way as the conventional offset smear removing method.

$$\begin{matrix}Δ {Q}_{i , 1} = 0 \\ Δ {Q}_{i , j} = \sum {Q}_{i , n} \\ = Δ {Q}_{i , j - 1} + {q}_{i , j - 1} \\ = Δ {Q}_{i , j - 1} + {Q}_{i , j - 1} \times ( {T}_{t} / J ) \div {T}_{s} , j ≧ 2\end{matrix} \qquad ( 1 )$$

On the other hand, when the overflow is generated to the potential well 52 of the pixel (i, j) at the time of image capturing, the quantity of smear electric charge ΔQ_{i,j} has a value obtained by subtracting the quantity of saturated electric charge Qₘₐₓ from the quantity of electric charge S_{i, j} transferred to the storing section 2s.

In other words, when S_{i, j}>Qₘₐₓ, the smear electric charge ΔQ_{i,j} is expressed by a mathematical formula (2).
ΔQ_{i,j}=S_{i, j}−Qₘₐₓ, j≧1 (2)

Here, Tₛ is the image capturing period, Q_{i,j} is the information electric charge generated in the pixel (i, j) during the image capturing period Tₛ, Tₜ is the transfer period, ΔQ_{i,j} is the smear electric charge to be added to the information electric charge Q_{i,j} during the transfer period, S_{i, j} is the quantity of electric charge of the pixel (i, j) transferred to the storing section 2s, and Qₘₐₓ is the quantity of saturated electric charge indicating the maximum value of the quantity of electric charge storable in the potential well 52 at the time of image capturing.

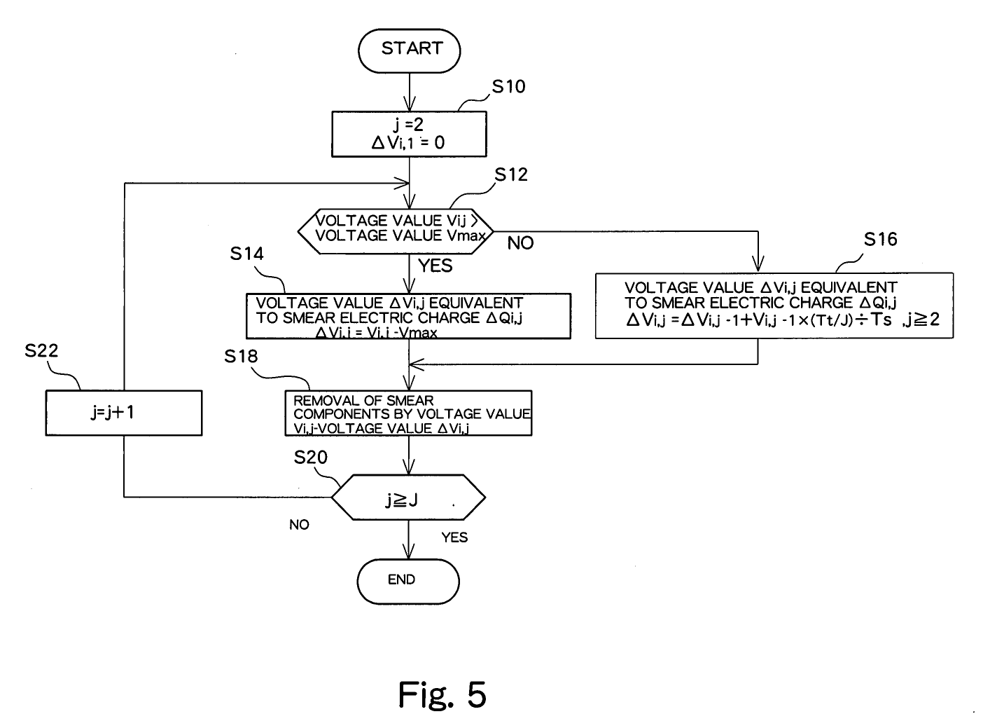

The CCD solid image capturing element 100 converts the quantity of electric charge S_{i,j} in sequence into an output voltage value V_{i,j} which is proportional to a quantity of electric charge thereof for outputting as a image signal. Then, in the image signal-processing device 104, a smear removing process is performed for the image signal along steps shown in a flowchart shown in FIG. 5.

In step S10, initial setting is made. In other words, a counter j is set at 2, and an output voltage value ΔV_{i,1} is set at 0 (zero). In step S12, determination is made whether the output voltage value V_{i,j} is larger than the saturated voltage value Vₘₐₓ at the time of image capturing equivalent to the quantity of saturated electric charge Qₘₐₓ. As the result, if the output voltage value V_{i,j} is larger than the saturated voltage value Vₘₐₓ at the time of image capturing, the process is proceeded to step S14. When the output voltage value V_{i,j} is smaller than the saturated voltage value Vₘₐₓ at the time of image capturing, the process is proceeded to step S16. It should be noted that the saturated voltage value Vₘₐₓ at the time of image capturing equivalent to the quantity of saturated electric charge Qₘₐₓ can be previously obtained.

In step S14, calculation of the smear components is performed based on the relation (2). Since the output voltage value V_{i, j}, the saturated voltage value Vₘₐₓ at the time of image capturing, and the smear voltage value ΔV_{i, j} corresponding to the smear electric charge ΔQ_{i, j} are respectively proportional to the quantity of electric charge S_{i, j}, the quantity of saturated electric charge Qₘₐₓ, and the smear electric charge ΔQ_{i, j}, the smear voltage value ΔV_{i, j} can be calculated by subtracting the saturated voltage value Vₘₐₓ at the time of image capturing from the output voltage value V_{i, j}, according to the relation (3).
ΔV_{i,j}=V_{i, j}−Vₘₐₓ, j≧1 (3)

On the other hand, in step S16, the smear components are calculated based on the relation (1). The smear voltage value ΔV_{i, j} is calculated by the relation (4).
ΔV_{i,j}=ΔV_{i, j-1}+V_{i, j-1}×(Tₜ/J)÷Tₛ, j≧2 (4)

In step S18, the value of the image signal X_{i, j} from which the smear components are removed is calculated by subtracting the smear voltage value ΔV_{i,j} from the output voltage value V_{i,j}. In step S20, determination is made whether the counter j arrived at the column number J of the image capturing section 2i. If the numeral of the counter j is larger than the numeral J of the column number, the smear removing process in the row is terminated. If the numeral of the counter j is smaller than the numeral J of the column number, the numeral of the counter j is increased by one to perform removing of the smear components of the pixel corresponding to the next column.

In other words, by making output voltage values V_{i, 2}, V_{i, 3}, . . . V_{i, j} from the same row i of the image capturing section 2i as targets, and by subtracting the smear voltage value A V_{i,j} in sequence from the output voltage value V_{i, j} outputted from the pixel (i,j) nearer to the storing section 2s, the smear components can be removed from the image signal.

It should be noted that even when the output from the output section 2d is not expressed by the voltage, the smear components can be removed from the photographed image by calculating for subtracting a value equivalent to the smear electric charge ΔQ_{i, j} from the output value in the same way.

<Modification>

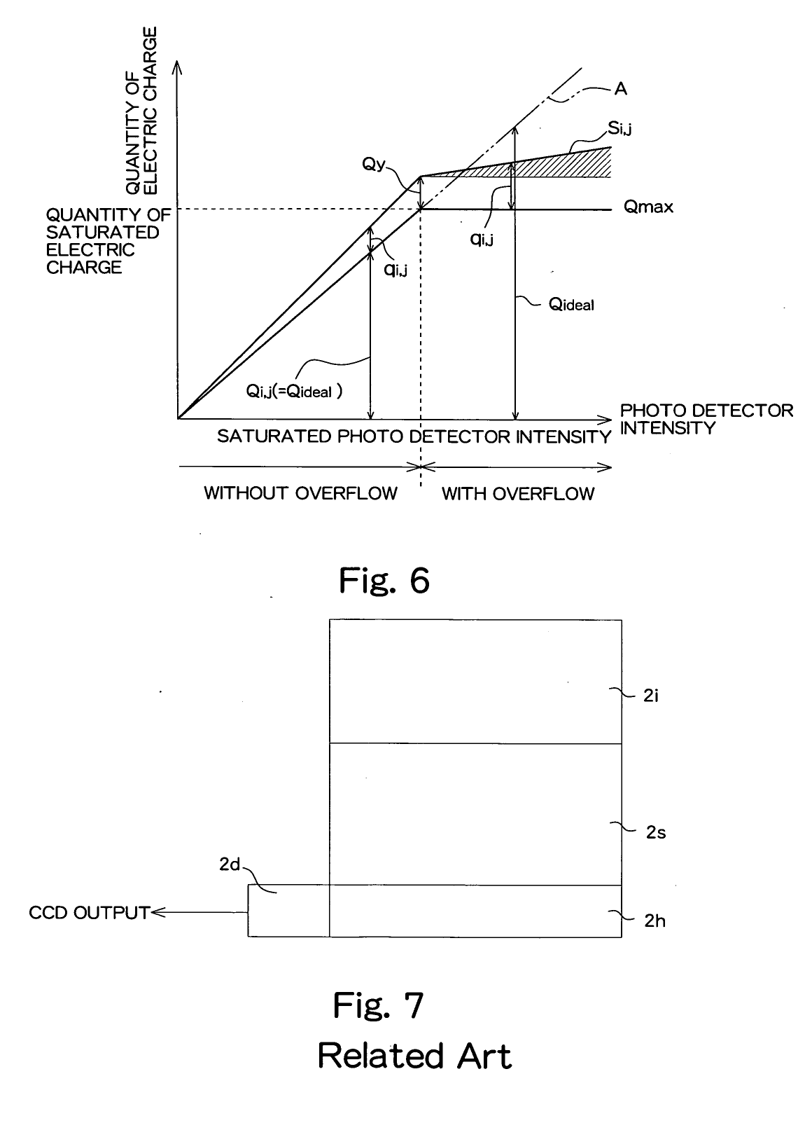

Shown in FIG. 6 is the relationship between a photo detector intensity in a pixel of the image capturing section 2i and a quantity of electric charge generated in the pixel during an image capturing period Tₛ and in a transfer cycle T.

In the above-described embodiment, as shown in FIG. 6, when an overflow is generated in observation pixel (i, j) at the time of image capturing, the image signal X_{i, j} from which the smear components for the observation pixel (i, j) is removed is calculated as:
V_{i, j}−ΔV_{i, j}=Vₘₐₓ,
where V_{i, j} being the output voltage value, ΔV_{i,j} being the smear voltage value, and Vₘₐₓ being the saturated voltage value at the time of image capturing. In other words, the signal value of the image signal X_{i, j} from which the smear components for the pixel in which the overflow is generated at the time of image capturing is not corresponding to the photo detector intensity, but is the signal value restricted to the saturated voltage value Vₘₐₓ at the time of image capturing equivalent to the quantity of saturated electric charge Qₘₐₓ.

However, an ideal output voltage value I_{i, j} to be outputted from the observation pixel (i, j) in an ideal state where no overflow is generated is, as shown as A in FIG. 6, a voltage value equivalent to an ideal quantity of electric charge Q_{ideal} in a case where no overflow is generated.

Here, the ratio between the ideal quantity of electric charge Q_{ideal} of the observation pixel (i, j) and a new electric charge q_{i, j} generated at the pixel (i, j) during the transfer of the information electric charge from the pixel (i, j) to the next pixel (i, j−1) in the transfer cycle T, equals to the ratio of the image capturing period Tₛ against the transfer cycle T. In other words, the ideal output voltage value I_{i, j} is a value obtained by multiplying the voltage value v_{i, j} equivalent to the quantity of electric charge q_{i, j} generated at the time of passing the observation pixel (i, j) in the transfer cycle T by the ratio of Tₛ/T, where Tₛ being the image capturing period and T being the transfer cycle.

In the present embodiment, since the potential well 54 at the time of transfer is larger than the potential well 52 at the time of image capturing, the smear voltage value ΔV_{i,j} transferred from the observation pixel (i, j) to the storing section 2s can be obtained by the mathematical formulas (3) and (4). Accordingly, the voltage value v_{i, j} due to the electric charge q_{i, j} generated at the observation pixel (i, j) in the transfer cycle T can be calculated by the mathematical formula (5).
ΔV_{i, 1}=ΔV_{i, 1}=0
Δv_{i,j}=ΔV_{i, j}−V_{i, j-1}, j≧2 (5)

Then, the ideal output voltage value I_{i, j} at the observation pixel (i, j) can be calculated by the mathematical formula (6) by use of the voltage value v_{i,j}.
I_{i, j}=v_{i, j}×Tₛ/T (6)

Since the electric charge q_{i, j} is generated by the impinged light beams during very short transfer period Tₜ, if the ideal voltage value I_{i,j} is calculated by use of the mathematical formula (6) when the overflow is generated during the image capturing period Tₛ, there is a possibility of an error becoming larger. Accordingly, it is preferable that the mathematical formula (6) is modified into the mathematical formula (7) by use of the quantity of saturated electric charge Vₘₐₓ at the time of image capturing and the voltage value V_{y} equivalent to the quantity of electric charge Q_{y} generated in the transfer cycle T in the pixel receiving the saturated photo detector intensity.

$$\begin{matrix}{I}_{i , j} = {V}_{max} + ( {v}_{i , j} - T / {T}_{s} \times {V}_{max} ) \times {T}_{s} / T \\ = {V}_{max} + ( {v}_{i , j} - {V}_{y} ) \times {T}_{s} / T\end{matrix} \qquad ( 7 )$$

As described above, the ideal output voltage value I_{i,j} to be outputted from the observation pixel (i, j) in the ideal state where no overflow is generated can be calculated based on a flow in FIG. 5 for the pixel in which the overflow is actually not generated, and based on the mathematical formula (7) for the pixel in which the overflow is actually generated.

Further, in order to reduce the error due to the use of the voltage value v_{i, j}, a second term of the right side of the mathematical formula (7) may be multiplied by a coefficient α which is a positive number not larger than 1, as in the mathematical formula (8). At this time, the coefficient α can be fixed in accordance with the ratio of the image-capturing period Tₛ against the transfer cycle T. For example, the shorter the transfer cycle T is against the image capturing period Tₛ, the higher is the possibility that the error due to the use of the voltage value v_{i, j} is larger. Accordingly, it is preferable that the coefficient α is set in a smaller value.
I_{i, j}=Vₘₐₓ+α×(v_{i, j}−V_{y})×Tₛ/T (8)

As described above, according to the present embodiment, even when impinged by light beams strong enough to cause the overflow from the potential well 52 of the image capturing section 2i at the time of image capturing, the smear can be appropriately removed from the photographed image, thereby picture quality of the video signal obtained by the image capturing element can be improved.

It should be noted that the CCD solid image capturing element 100 to which the present invention is applicable is not limited to the CCD solid image capturing element having the make-up as shown in FIG. 7. For example, if the CCD solid image-capturing element is of a frame transfer system, the present invention can be similarly applied.

Furthermore, a method for modulating the capacities of the potential well 52 formed in the image capturing section 2i at the time of image capturing and the potential well 54 formed in the image capturing section 2i at the time of transfer is not limited to the method of modulating the voltage applied to the transfer electrodes 26. For example, the capacity of the potential well 54 at the time of transfer can be made larger than the capacity of the potential well 52 at the time of image capturing, if the image capturing section 2i is made with a four phase gate structure, only one transfer electrode is put in the turned-on state at the time of image capturing, and at least two transfer electrodes are held in the turned-on state for performance of the transfer at the time of transfer. Moreover, for example, if a storing area for storing the information electric charge and a channel area for transferring the information electric charge are separately provided in the image capturing section 2i, and respective areas are formed by respectively different doping distributions, potential wells having different capacities can also be formed.

Although the invention has been described with respect to specific embodiments for a complete and clear disclosure, the appended claims are not to be thus limited but are to be construed as embodying all modifications and alternative constructions that may occur to one skilled in the art which fall within the basic teaching herein set forth.

1. A image signal-processing device for processing a image signal outputted from a solid image capturing element, wherein,
one of elements contained in the solid image capturing element is designated as an observation element, and
a value obtained by subtracting a signal value equivalent to a quantity of saturated electric charge from the image signal outputted from said observation element is processed as a signal value equivalent to a quantity of smear electric charge added during a transfer period, when the signal value outputted from the observation element is larger than the signal value equivalent to the quantity of saturated electric charge storable in the observation element at a image capturing period.

2. The image signal processing device according to claim 1, wherein,
the solid image capturing element has a pixel to generate for storing the electric charge in accordance with an intensity of impinged light beams, and outputs the image signal in accordance with the quantity of electric charge by transferring the electric charge, and a quantity of saturated electric charge storable in the pixel at the transfer period is larger than the quantity of saturated electric charge storable in the pixel at the image capturing period.

3. The image signal processing device according to claim 1, wherein,
an ideal output value larger than the signal value equivalent to the quantity of saturated electric charge storable in the observation element at the image capturing period is calculated based on the signal value equivalent to the quantity of smear electric charge.

4. A image signal processing device for processing a image signal outputted from a solid image capturing element, wherein,
the solid image capturing element contains a plurality of pixels (i, j), (i≧1), and (J≧j≧1) arranged in a matrix in the numeral J of columns storing an electric charge generated in accordance with impinged light beams, is provide with an image capturing section of which a quantity of electric charge storable in respective pixels (i, j) at a image capturing period is a quantity of saturated electric charge Qₘₐₓ, and transfers in a transfer cycle T and in sequence an electric charge Q_{i, j} stored in the respective pixels (i, j) of the image capturing section during the image capturing period Ts for outputting as a image signal V_{i, j} corresponding to the pixel (i, j), and when a quantity of saturated electric charge storable in the pixel at a transfer period is larger than the quantity of saturated electric charge Qₘₐₓ storable in the pixels at the image capturing period, setting is made as:
ΔV_{i, j}=V_{i, j}−Vₘₐₓ,
when a value of the image signal V_{i, j} is larger than a signal value Vₘₐₓ equivalent to the quantity of saturated electric charge Qₘₐₓ,
ΔV_{i, 1}=0, or
ΔV_{i, j}=ΔV_{i, j-1}+V_{i, j-1}÷T/Tₛ (j is not less than 2), when the value of the image signal V_{i, j} is not larger than the signal value Vₘₐₓ, and
the smear voltage value ΔV_{i,j} is provided for the correction processing of the image signal.

5. The image signal processing device according to claim 4, wherein,
a calculation is performed by the following setting; namely,
a signal value v_{i, j} due to the electric charge generated in the pixel (i, j) in the transfer cycle T is set as;
v_{i, 1}=0, or
v_{i, j}=ΔV_{i, j}−ΔV_{i, j-1}, (j is not smaller than 2),
a signal value equivalent to the electric charge generated in said transfer cycle T in the pixel storing the quantity of saturated electric charge Qₘₐₓ during the image capturing period Tₛ is set as V_{y}, and
an ideal output value I_{i, j} in a case where the image signal V_{i, j} is larger than the signal value Vₘₐₓ is set as;
I_{i, j}=Vₘₐₓ+α×(v_{i, j}−V_{y})×Tₛ/T, (0<coefficient α≦1).

6. A method for processing a image signal for processing a image signal outputted from a solid image capturing element, wherein one of the elements contained in the solid image capturing element is designated as an observation element, comprising;
a first step for determining whether a value of the image signal outputted from the observation element is larger than a signal value equivalent to a quantity of saturated electric charge storable in the observation element at a image capturing period, and
a second step for setting a value obtained by subtracting the signal value equivalent to the quantity of saturated electric charge from the value of the image signal outputted from the observation element as the signal value equivalent to a quantity of smear electric charge added during a transfer period, when the signal value outputted from the observation element is determined in said first step to be larger than the signal value equivalent to the quantity of saturated electric charge storable in the observation element at the image capturing period.

7. The method for processing the image signal according to claim 6, wherein;
the solid image capturing element has a pixel for generating to store the electric charge in accordance with the intensity of impinged light beams, and outputs a image signal in accordance with a quantity of electric charge by transferring the electric charge, and a quantity of saturated electric charge storable in the pixel at the transfer period is larger than the quantity of saturated electric charge storable in the pixel at the image capturing period.

8. The method for processing the image signal according to claim 6, further comprising;
a third step for calculating an ideal output value larger than the signal value equivalent to the quantity of saturated electric charge storable in the observation element at the image capturing period based on the signal value equivalent to the quantity of smear electric charge.

9. A method for processing a image signal for processing the image signal outputted from a solid image capturing element, wherein,
the solid image capturing element contains a plurality of pixels (i, j), (i≧1), and (J≧j≧1) arranged in a matrix in the numeral J of columns storing an electric charge generated in accordance with impinged light beams, is provided with an image capturing section where a quantity of electric charge storable in respective pixels (i, j) at a image capturing period is a quantity of saturated electric charge Qₘₐₓ, and transfers in a transfer cycle T and in sequence, an electric charge Q_{i, j} stored in the respective pixels (i, j) of the image capturing section during the image capturing period Tₛ for outputting as a image signal V_{i, j} corresponding to the pixel (i, j), and when a quantity of saturated electric charge storable in the pixel at a transfer period is larger than a quantity of saturated electric charge Qₘₐₓ storable in the pixel at the image capturing period, the following steps are performed while the value of j is being increased, the steps comprising;
a first step for determining whether a signal V_{i, j} is larger than a signal value Vₘₐₓ equivalent to the quantity of saturated electric charge Qₘₐₓ,
a second step for setting as:
ΔV_{i, j}=V_{i, j}−Vₘₐₓ,
when the image signal V_{i, j} is determined in said first step to be larger than the signal value Vₘₐₓ equivalent to the quantity of saturated electric charge Qₘₐₓ, and
a third step for setting as;
ΔV_{i, 1}=0, or
ΔV_{i, j}=ΔV_{i, j-1}+V_{i, j-1}÷T/Tₛ (j is not less than 2), when the image signal V_{i, j} is determined in said first step to be not larger than the signal value Vₘₐₓ, and,
the smear voltage value ΔV_{i,j} is provided for a correction processing of the image signals.

10. The method for processing the image signal according to claim 9, further comprising a fourth step for calculating, wherein;
a signal value v_{i, j} due to the electric charge generated in the pixel (i, j) in the transfer cycle T is set as;
v_{i, 1}=0, or
v_{i, j}=ΔV_{i, j}−ΔV_{i, j-1}, (j is not smaller than 2),
a signal value equivalent to the electric charge generated in said transfer cycle T in the pixel storing the quantity of saturated electric charge Qₘₐₓ during the image capturing period Tₛ is set as V_{y}, and
an ideal output value I_{i, j} in a case where the signal value V_{i, j} is larger than the signal value Vₘₐₓ is set as;
I_{i, j}=Vₘₐₓ+α×(v_{i, j}−V_{y})×Tₛ/T, (0<coefficient α≦1).

11. A image signal processing program product for processing a image signal outputted from a solid image capturing element, wherein,
one of elements contained in the solid image capturing element is designated as an observation element, and
the computer is rendered to function as a image signal processing device for processing a value obtained by subtracting a signal value equivalent to a quantity of saturated electric charge from a signal value outputted from said observation element as a signal value equivalent to a quantity of smear electric charge added during a transfer period, when the signal outputted from the observation element is larger than the signal value equivalent to said quantity of the saturated electric charge storable in said observation element at a image capturing period.

12. The image signal processing program product according to claim 11, wherein,
the solid image capturing element has a pixel for generating to store the electric charge in accordance with an intensity of impinged light beams, and outputs the image signal in accordance with the quantity of electric charge by transferring the electric charge, and a quantity of saturated electric charge storable in the pixel at the transfer period is larger than the quantity of saturated electric charge storable in the pixel at the image capturing period.

13. The image signal processing program product according to claim 11, wherein,
the computer is rendered to function as a image signal processing device for calculating an ideal output value which is larger than the signal value equivalent to the quantity of saturated electric charge storable in the observation element at the image capturing period based on the signal value equivalent to the quantity of smear electric charge.

14. A control device of a solid image capturing element, provided with an image capturing section having a plurality of pixels arranged in a matrix, for storing an electric charge generated in accordance with light beams impinged on the pixels during an image capturing period, and for transferring in sequence the electric charge stored in respective pixels during a transfer period, wherein,
a capacity of a potential well formed in said image capturing section during the transfer period is made larger than a capacity of the potential well formed in said image capturing section during the image capturing period.

15. A method for controlling a solid image capturing element, provided with an image capturing section having a plurality of pixels arranged in a matrix, for storing an electric charge generated in accordance with light beams impinged on the pixels during an image capturing period, for transferring in sequence the electric charge stored in respective pixels during a transfer period, wherein,
a capacity of a potential well formed in said image capturing section during the transfer period is made larger than a capacity of the potential well formed in said image capturing section during the image capturing period.
